(19) United States
(12) Patent Application Publication
(10) Pub. No.: US 2008/0086690 A1
(43) Pub. Date: Apr. 10, 2008

(54) Method and System for Hybrid Call Handling

(76) Inventors: Ashish Verma, New Delhi (IN); Nitendra Rajput, New Delhi (IN); Sreeram Viswanath Balakrishnan, New Delhi (IN); Tanveer Afzal Faruquie, New Delhi (IN)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/534,000

(22) Filed: Sep. 21, 2006

(51) Int. Cl. G06F 15/177

(52) U.S. Cl. 715/736

(57) ABSTRACT

The present invention provides a hybrid call handling method and system. The method comprises navigating a plurality of received calls from a plurality of callers. The method further comprises monitoring a call health status for each of the plurality of the calls being navigated for entire call duration and notifying a bad call health status of the monitored call to a human agent for employing at least one rectification action. The call health status is determined by monitoring and measuring one or more call parameters. The invention provides for a system for call handling and navigation by an automated system with a human agent assisting the automated system for rectification of calls with bad call health status. Once the call with a bad health is transferred to the human agent, he assists the automated system either by directly communicating with the caller or by communicating using a machine interface.

### FIELD OF THE INVENTION

The present invention relates to a method and system for handling an incoming call from a caller. More specifically, the present invention relates to a method and system for handling the incoming call that is answered by an automated system with a human agent assisting the automated system.

### BACKGROUND OF THE INVENTION

In the present business scenarios, it is vital for any type of product/service-oriented company to lend caller support in order to stay active in the competitive market. Many service providers provide caller support and product related services through a call center. Call center may be located anywhere across the globe to provide caller service on a 24/7 basis and in a cost effective way. Normally, the company provides its telephone number or numbers to call centers to which a caller calls to receive desired caller support. Several practices are available in the art for handling a caller's incoming call at a call center.

In one of the known methods, the incoming calls are handled by human agents (hereinafter, also referred to as call operators). The human agents interact with the caller to provide the services desired by the caller. Since the caller conveys the query or complaint directly to the human agent, the incoming calls attended by the human agents generally result in higher caller satisfaction. However, the cost incurred to the call center is very high due to the involvement of the human agents. Moreover, due to the limited number of the human agents in the call center at any given time, the caller might have to wait for a long time before being attended by the human agent. This waiting process to handle and answer the caller query may annoy the caller. Also, the caller may bear additional call costs incurred during the caller's idle waiting time until a human agent handles the call.

Another commonly known method for handling incoming calls is the use of an Interactive Voice Response (IVR) system. The IVR system is a computerized system that allows a caller to select an option from, for example, a voice menu or a telephone keypad. In the IVR system, pre-recorded voice prompts are played to which the caller responds. The caller might respond by either pressing a number on the telephone keypad to select the desired option conveyed by the voice prompts, or the caller might reply to the voice prompts. The caller's reply may be a “yes” or a “no” or a number.

With the tremendous advancement in technologies such as speech recognition, text-to-speech synthesis and natural language understanding, the effectiveness of IVR systems is increased substantially. IVR systems, using natural language speech recognition technology, interpret a caller's questions and accordingly provide a service. IVR systems can be used to provide services to the callers in service industries including telephone banking, order placement, caller identification and airline ticket booking.

IVR systems are also used at the front end of a call center and interact with a caller. IVR systems do not suffer from accent drawbacks as opposed to the human agents. However, IVR systems are often criticized by callers as unhelpful and difficult to interact with due to poor architectural design of IVR systems and due to limitations of the underlying speech recognition and natural language understanding technologies. Although IVR systems serve as a good alternative for call centers worldwide as they lower operating costs by increasing automation in handling the incoming calls, they are not completely reliable as they cannot handle callers' needs satisfactorily.

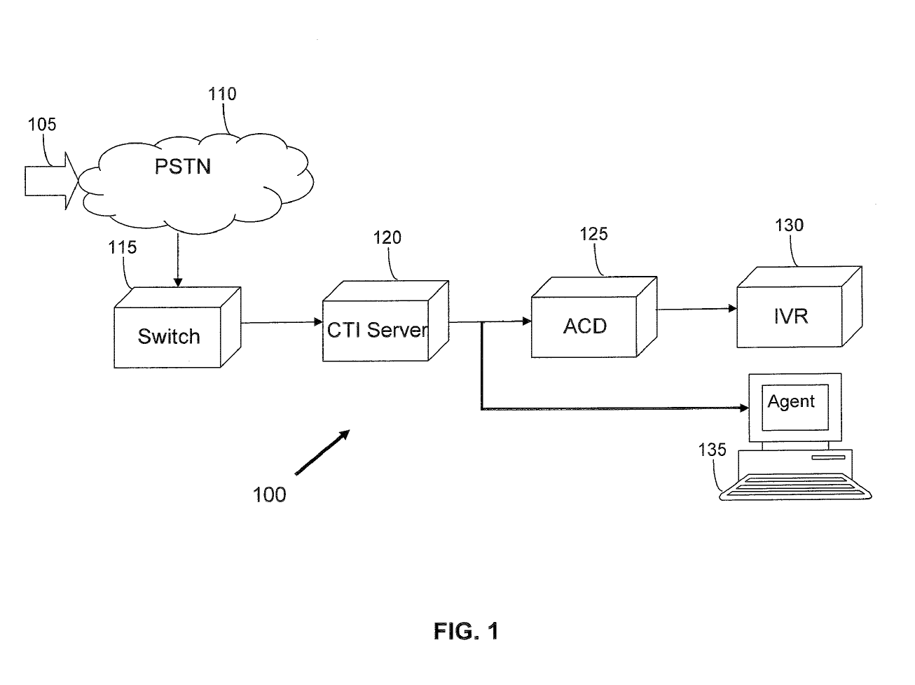

One of the possible implementations of handling the incoming calls either at the IVR system or by a human agent is depicted in FIG. 1. The figure illustrates a system 100 including an incoming call 105, a Public Switched Telephone Network (PSTN) 110, a switch 115, a Computer Telephony Integration (CTI) server 120, an Automatic Call Distributor (ACD) 125, an IVR 130 and a human agent 135. When CTI server 120 receives incoming call 105 routed via PSTN 110 and switch 115, it directs incoming call 105 either to ACD 125 or human agent 135 depending upon a routing criteria applied at CTI server 120. In case incoming call 105 is routed to ACD 125, the incoming call is handled by IVR 130. However, the drawback of the aforesaid implementation is inflexibility and predetermined routing criteria. Therefore, seamless call handling between the IVR 130 and human agent 135 is not possible. Moreover, call specific automation and call specific error handling is not possible.

In other solutions, speech-based IVR systems are used to completely automate the manual call-center operations by human agents. However in such settings, if the automated system fails to solve the caller request, then there is no way for calls to automatically fall back to the human agent.

In an attempt to solve the aforesaid problems, yet another method known in the art makes use of both an IVR system and human agents. In accordance with one method using both an IVR system and human agents, the automated system may be used initially to categorize the nature of the call (e.g., product enquiry, purchase, account number, after sales services, etc.), then the incoming call may be transferred to the human agent at a division associated with the category. In accordance with another method, the incoming call may be transferred to the human operator if the automated system is not able to understand the caller's query. In either scenario, the caller interacts with multiple interfaces (the human agent and the automated system) and might have to repeat a lot of information that the caller has already provided. Moreover, the limited capability of the automated system is non-transparent to the user and frequent switching between the interfaces may irritate the caller.

Therefore, there is a need for an improved method and system that overcomes the aforesaid limitations and utilizes both an interactive voice response (IVR) system and human agent in synchronization.

### SUMMARY OF THE INVENTION

The present invention meets the aforementioned needs by providing a hybrid call handling method. The method comprises navigating a plurality of received calls from a plurality of callers while monitoring a call health status, (as explained subsequently in this document) for each of the plurality of the calls being navigated for an entire call duration and notifying a bad call health status of a monitored call to a human agent for employing at least one rectification action.

The present invention further provides a hybrid call handling system for the interaction of an automated system and a human agent with a plurality of callers. In the present invention, a call is handled using a combination of an automated system and a human agent resulting in effective utilization of the human agent's time.

In an embodiment, a call is answered by an IVR system and the health of the call, is maintained by the automated system. Once the health of the call is detected to be bad, the automated system seeks the help of a human agent. The history and the context of the call are presented to the human agent and the human agent provides the desired inputs to the automated system to enable the automated system to recover the call from the “bad call health” status.

In the proposed invention, the human agent does not interact with the caller directly, thereby ensuring a uniform caller experience as the caller's interface remains unchanged for the entire duration of the call. Since the human agent is involved only for the duration required to rectify the bad call health by employing one or more corrective actions, the human agent is capable of handling multiple incoming calls simultaneously.

In yet another embodiment, a call is attended by a human agent but he does not speak directly to the caller. The human agent uses a text-to-speech system in the caller's accent to interact with the caller. Since the human agent interacts with the caller using a text-to-speech system, the method does away with the language and the accent skill requirement of the human agent.

These and other aspects, advantages and salient features of the present invention will become apparent from the following detailed description, the accompanying drawings, and the appended claims.

### BRIEF DESCRIPTION OF THE INVENTION

FIG. 1 is an illustration of a prior art.

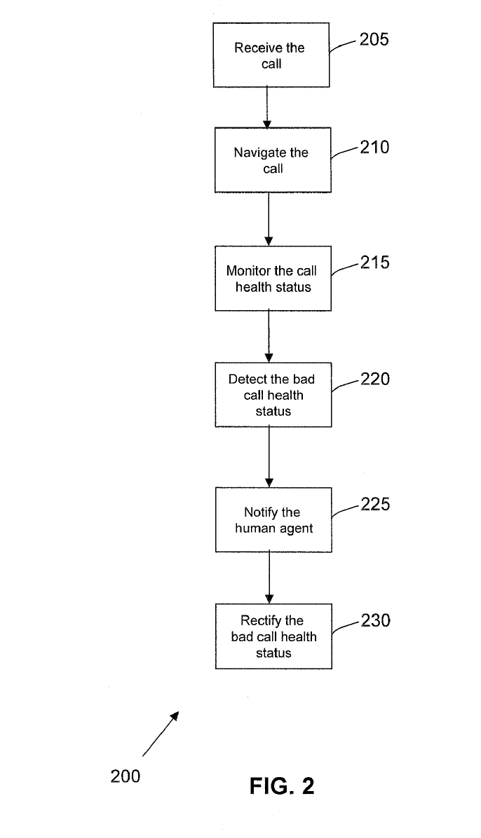

FIG. 2 is a flow diagram of a call handling method in accordance with an embodiment of the present invention.

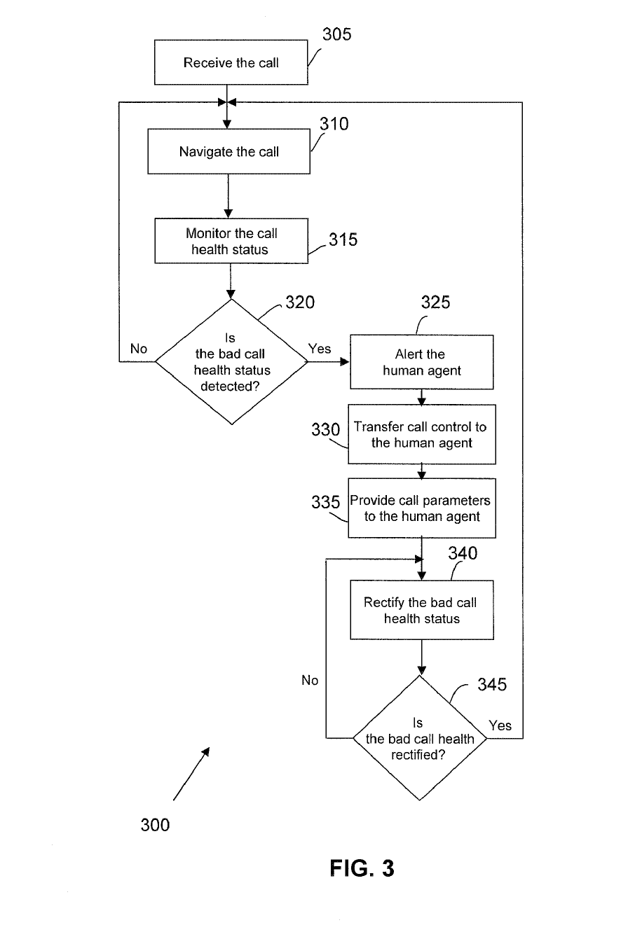

FIG. 3 is a flow diagram of a hybrid call handling method in accordance with another embodiment of the present invention.

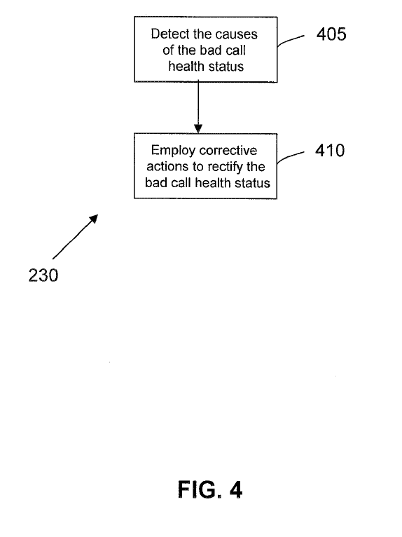

FIG. 4 is an exemplary illustration of the sub-steps of a rectification method of a bad call health status in accordance with an embodiment of the present invention.

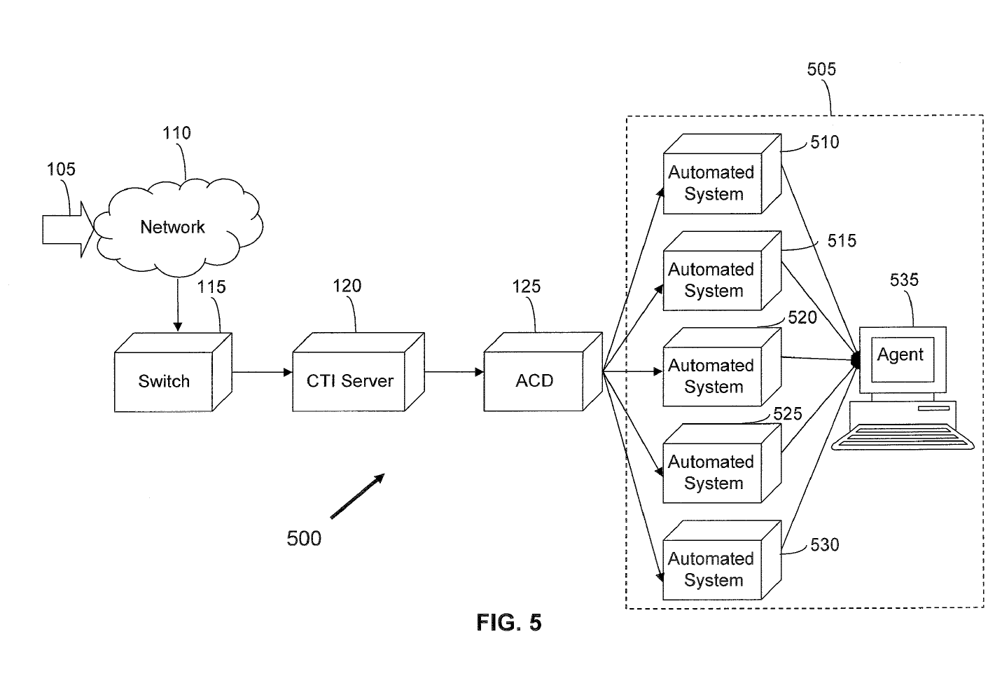

FIG. 5 illustrates an environment of a hybrid call handling system in accordance with an embodiment of the present invention.

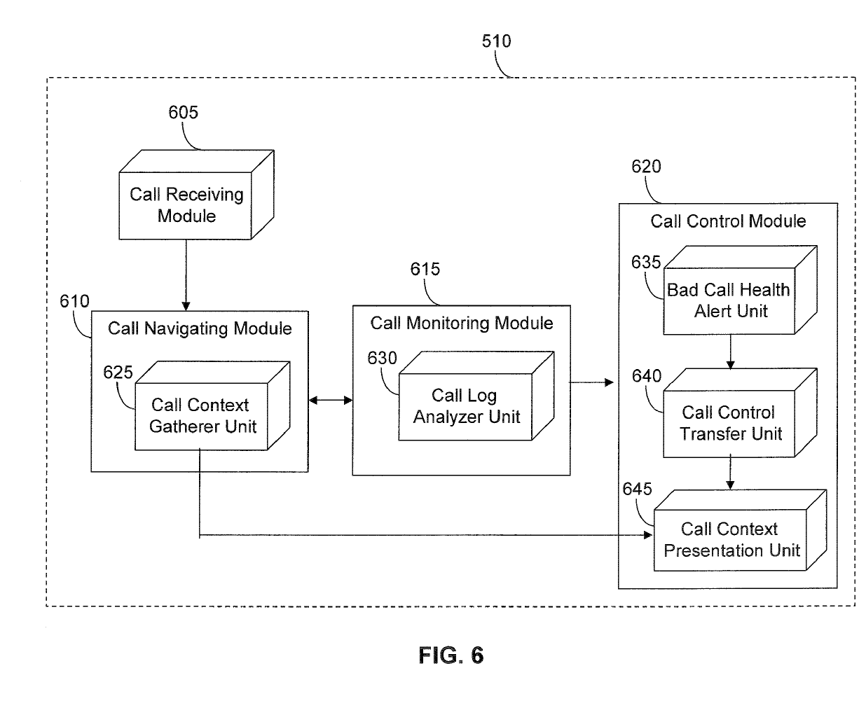

FIG. 6 is a block diagram of an automated system of the hybrid call handling system in accordance with an embodiment of the present invention.

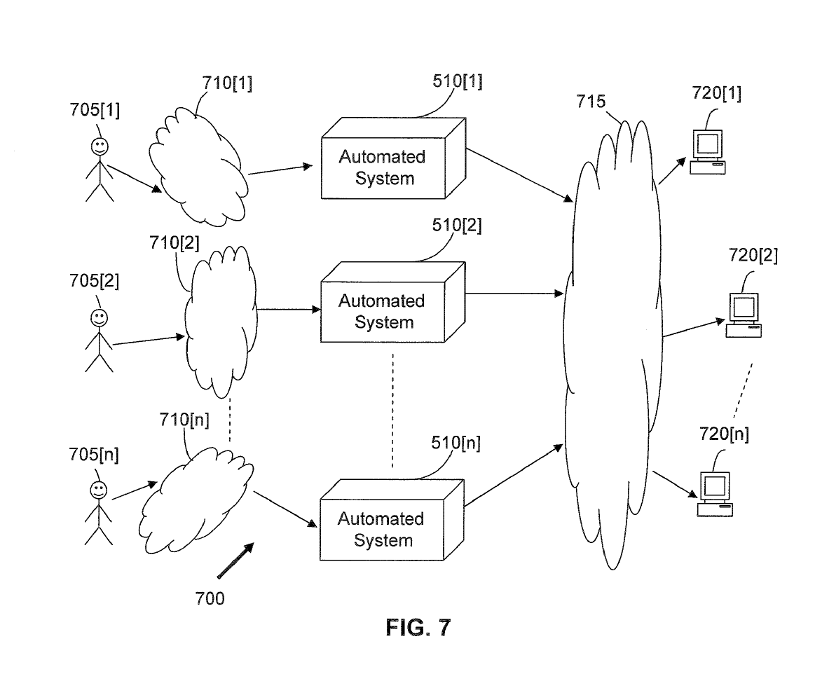

FIG. 7 is a block diagram of a hybrid call handling system in accordance with an embodiment of the present invention.

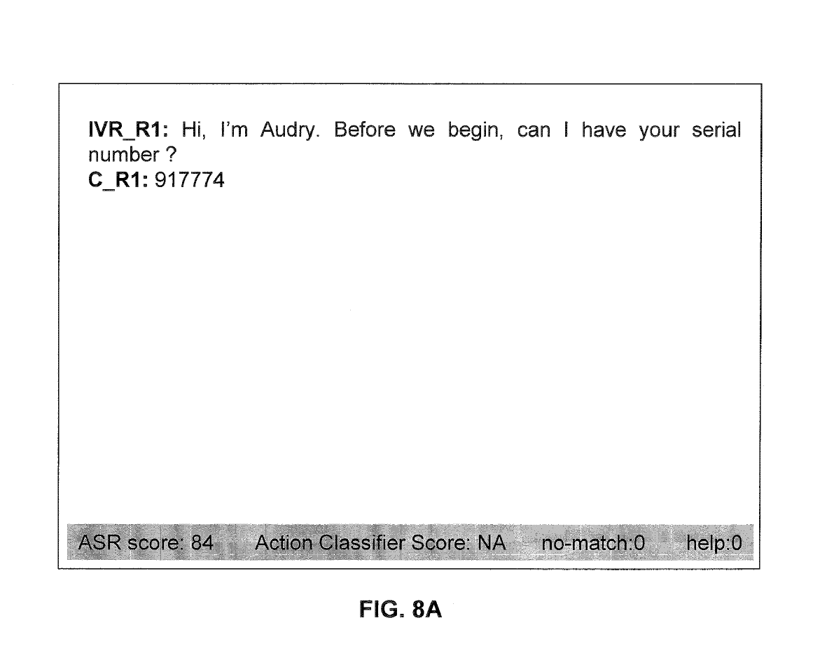

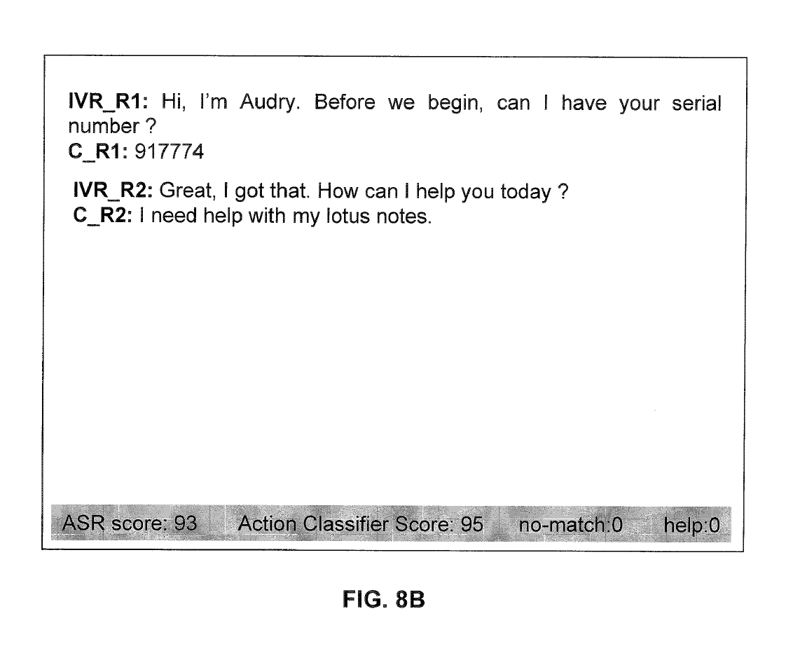

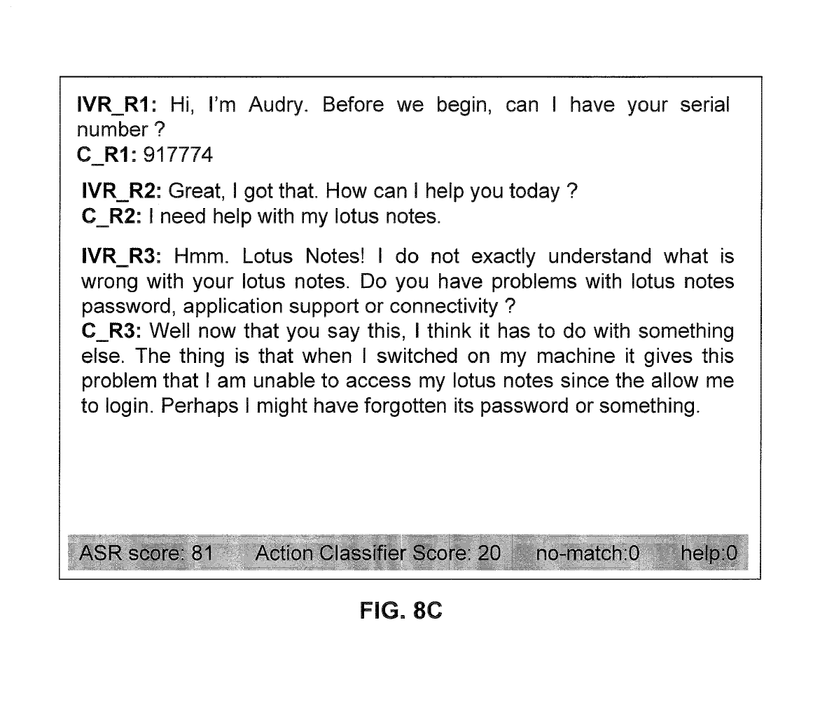

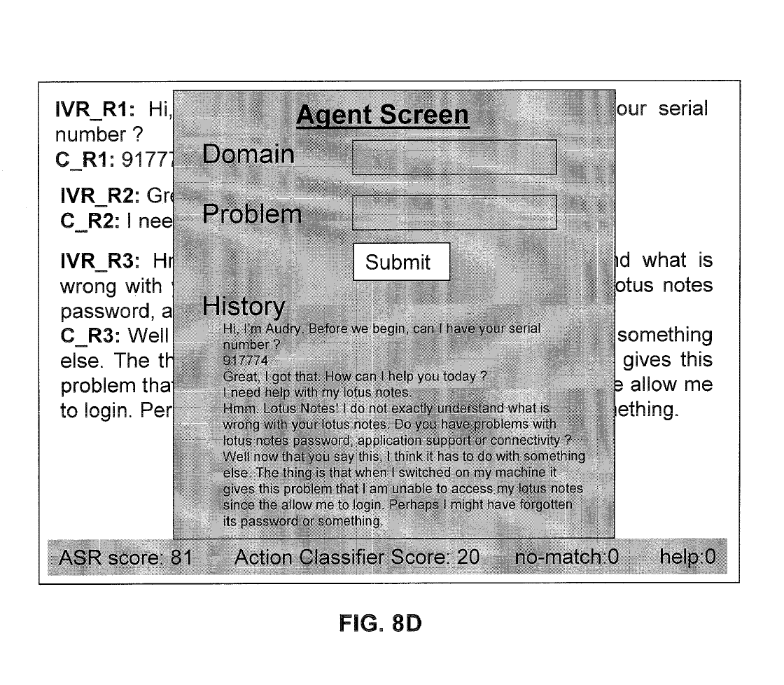

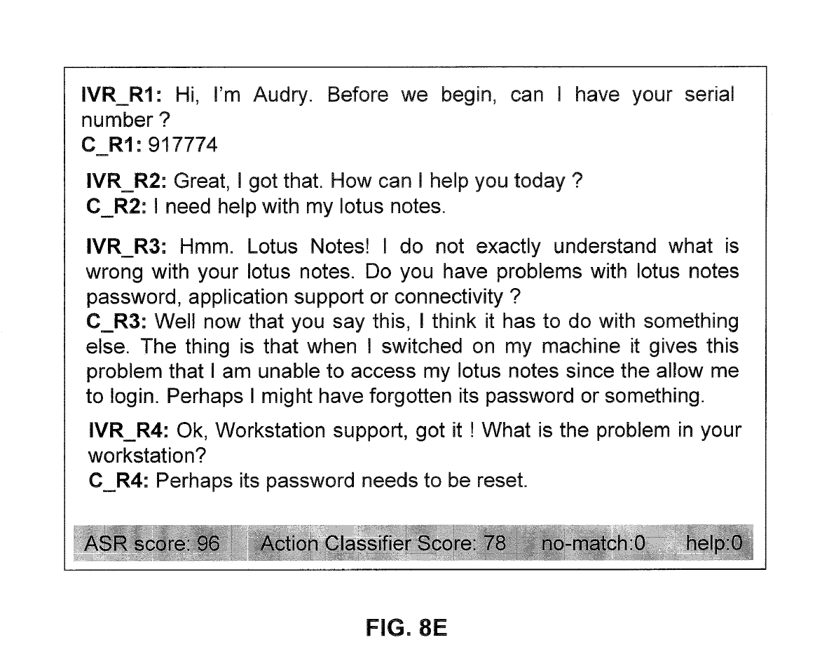

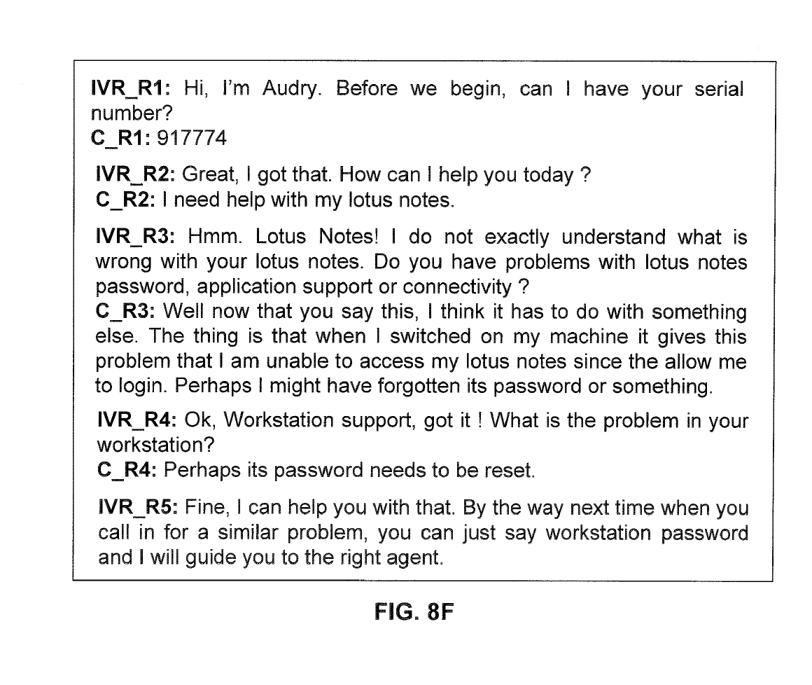

FIGS. 8A-8F illustrate an exemplary implementation of the present invention.

### DETAILED DESCRIPTION

In the present invention, a call is handled using a combination of an automated system and a human agent resulting in effective utilization of the human agent's time.

In an embodiment, a call is answered by an IVR system and the “health of the call”, as explained subsequently in this document, is maintained by the automated system. The “health of the call” may involve, for example, threshold scores associated with the speech recognition system, action classification scores and such parameters associated with other such sub-systems. Once the health of the call is detected to be bad, which may be determined by low threshold scores of for example, the sub-systems, unusual routes traversed by the call flow between the caller and the automated system and other such unusual conditions, the automated system seeks the help of a human agent. The history and the context of the call are presented to the human agent and the human agent provides the desired inputs to the automated system to enable the automated system to recover the call from the “bad call health” status. The automated system may then continue to handle the call without the help of the human agent.

In the proposed invention, a human agent may never interact with a caller directly, therefore the caller's interface remains unchanged for the duration of the call. Since the human agent is involved only for the duration required to rectify the bad call health by employing the corrective actions, the human agent is capable of handling multiple incoming calls simultaneously.

In the foregoing description, specific embodiments of the present invention have been described by way of examples with reference to the accompanying figures and drawings. One of ordinary skill in the art will appreciate that various modifications and changes may be made to the embodiments without departing from the scope of the present invention as set forth in the claims below. Accordingly, the specification and figures are to be regarded in an illustrative rather than a restrictive sense, and all such modifications are intended to be included within the scope of the present invention.

In one embodiment, the present invention provides a hybrid call handling method of interaction with a plurality of callers. In another embodiment, the present invention provides a hybrid call handling system. In yet another embodiment, the present invention provides a hybrid call handling system for detection and rectification of a bad call health status.

Referring to the drawings in general and to FIG. 2 in particular, it will be understood that the illustrations are for the purpose of describing an embodiment of the present invention and are not intended to limit the present invention thereto. Turning to FIG. 2, a flow diagram of one embodiment of a call handling method of the present invention is shown. The call handling method is a hybrid call handling method 200 that enables interaction of a plurality of callers with a hybrid call handling system over a network. At step 205, the plurality of calls is received from the plurality of callers. In one embodiment of the present invention, a call may be received by an automated system that may be an Interactive Voice Response System. In another embodiment, the call may be received by a machine interface operated by a human agent. In the context of the present invention, a machine interface is generally understood to imply an electronic or electrical device or response that greets the plurality of callers. In step 210, the automated system navigates the plurality of received calls. The navigation of calls includes navigating the interaction between the IVR and the caller, and gathering a context of the received call. The context includes, for example, all prompts in text and the corresponding Automatic Speech Recognition (ASR) transcribed text. At step 215, the automated system monitors a call health status of the call being navigated for the entire duration. In the context of the present invention, a call health status is generally understood to imply that the received call is met with a qualitative response that would provide for a high degree of caller satisfaction. The call health status is usually determined by monitoring one or more call parameters including the call flow pattern, the duration of the call, the speech recognition accuracy, repetition of the prompts played to the caller, a call priority status, the probability of a non-native caller accent, stability of the call, the call history and a change in the caller's emotional state as perceived by the automated system. In one embodiment of the present invention, the call parameters are determined using call analysis tools. The call analysis tools include tools like Nemesysco and NEIMO.

The call history comprises a call log, an ASR score for each prompt, an Action Classification Score (ACS) for each prompt, and number of events for each prompt. The number of events includes help and no-match events. In the context of the present invention, the prompt is generally referred to, without any limitation, as a voice response provided by the IVR. The ASR score, a quantitative score, is computed based upon the number of words correctly recognized in the callers' speech. The action classification score, a quantitative score, is computed based on the ability of the automated system to understand the callers' query. A high ACS means that the automated system may handle the callers query while if the ACS is low, the call control is passed to the human agent. The no-match event is used by the automated system to comprehend a caller's response. In an embodiment, a no-match event may be maintained using a counter and the counter may be configured to increment by one each time the automated system is unable to understand a caller's response. However, it will be apparent to a person skilled in the art that other logics used to maintain the no-match event fall within the spirit and scope of the present invention, for example voiceXML may be used to for creating voice user interfaces that use automatic speech recognition (ASR) and text-to-speech synthesis (TTS). Similarly, a help event may be determined using a counter. The counter maintains a track of the number of times a caller asks for the automated system's help. For example, each time a caller requests for help, the counter is incremented by one. Thus, the value of the counter may help in determining the caller's understanding and ease with the automated system.

Each of the call parameters is assigned a threshold value prior to handling of the calls. The threshold value may either be a number or a context-dependent attribute. The call health status is determined based on whether the call parameters reside in the pre-assigned threshold values. If at least one of the call parameter does not fall within the pre-assigned threshold value, the call health status is referred to as bad call health. The bad call health status is detected at step 220. An unacceptable, or bad call health status, as it is generally referred to in the art, is typically quantified, without limitation, from a series of events, attributes, or behavioral data that is generally available to a person skilled in the art. These include, without limitation, the repetition of prompts by the system, a caller with a non-native accent, a change in the emotional state of the caller, wherein the caller may indulge in shouting or demonstration of anger and the like, a lower confidence level in the understanding of the caller query, and strange or unusual call routes in the call flow.

Next, the human agent is notified the bad call health status of the monitored call at step 225. In one embodiment of the current invention, the human agent intervenes using the machine interface to handle the monitored call as opposed to interacting with the caller directly, thereby providing a single automated interface to the caller. In another embodiment, notifying comprises transferring the call control of the monitored call to the human agent. In step 230, the human agent rectifies the bad call health by interacting with the caller using the machine interface. In one embodiment, the method of the present invention optionally provides for transferring the call control back to the automated system upon rectification of the bad call health status.

FIG. 3 is a flow diagram of a hybrid call handling method 300 to provide interaction with a plurality of callers according to an embodiment of the present invention. At step 305, the plurality of calls is received from the plurality of callers. At step 310, the automated system navigates the plurality of received calls. At step 315, the call health status is monitored for the entire call duration of the call being navigated by monitoring one or more call parameters which have at least one pre-assigned confidence values. At step 320, a check is made to detect the bad call health status of the call being monitored. If the call health status is healthy, the call is continued to be navigated and its status is continued to be monitored. If the bad call health status is detected, the human agent is alerted at step 325. In one of the embodiments of the present invention, the human agent may be alerted by at least one of the visual alerts, for example, the automated system may raise a flag to attract the attention of the human agent. In another embodiment of the present invention, the human agent may be alerted by at least one of the audible alerts, for example, the automated system may raise an alarm to attract the attention of the human agent.

At step 330, the call control is transferred to the human agent. At step 335, at least one call parameter is provided to the human agent to enable the human agent to rectify the bad call health status. The call parameters comprise at least one of the call flow, duration of the call, the caller's inputs, prompts played back to the caller, a call priority status, probability of a non-native caller accent, and the stability of a caller's emotional state. The human agent rectifies the bad call health status at step 340. The human agent to whom the call is transferred for rectification may be the same human agent who received the call initially. This human agent controls the flow of the call and guides the caller more actively based on the analysis of the call parameters. Alternatively, the call may be escalated for rectification to a different human agent. The different human agent may have skill sets or training better suited to deal with calls with bad call health status. The two human agents may be co-located or may interact with each other through a network. At step 345, a check is made to determine whether the bad call health is rectified. The step 340 is repeated iteratively until the bad call health status is rectified. However, if the bad call health is rectified, the call control is transferred back to the step 310.

FIG. 4 is an exemplary illustration of the sub-steps of the method step 230 to enable the rectification of the bad call health status. At step 405, the human agent analyzes the call parameters to determine one or more causes for the bad call health status. At step 410, the human agent employs one or more corresponding corrective actions to rectify the bad call health status. For example, the human agent may rectify the bad call health status by guiding the call flow to improve the call health. The human agent may have access to the complete history of the call (for example, call log) and may use the context to analyze and correct the error, for example, if the automated system is not able to recognize a particular word spoken by a caller, the human agent may listen to a recording of the caller during the call and input the recording into the automated system. It will be obvious to one skilled in the art that any other method to rectify the bad call health status falls within the spirit and scope of the present invention.

Depending upon the applications and requirements, several embodiments of the present invention may be implemented.

In one of the embodiments of the present invention, whenever the bad call health is detected by the automated system, the automated system may raise an alert to get assistance from the human agent. The human agent may enter the required inputs, for example, misrecognized text or a different route for the call flow to follow. The automated system subsequently proceeds to the next process step with the caller.

In another embodiment, whenever the bad call health is detected by the automated system, the human agent takes over but the caller still interacts with the same interface. The human agent may enter the text that he might want to speak into the text-to-speech system which may get synthesized to the caller. In many situations, the human agent may speak predetermined phrases; therefore shortcuts may be used instead of typing the full text into the automated system. In other scenarios, the human agent may speak into the automated system and his speech may get recognized and further synthesized using the Text-to-Speech engine.

In yet another embodiment of the present invention, the call is always attended by the human agent although the human agent does not speak directly to the caller. The human agent always uses a text-to-speech system in the caller's accent to speak to the caller.

FIG. 5 is an illustration of an environment 500 of a hybrid call handling system in accordance with an embodiment of the present invention. The figure illustrates incoming call 105, network 110, switch 115, Computer Telephony Integration (CTI) server 120, Automatic Call Distributor (ACD) 125, and a hybrid call handling system 505. Hybrid call handling system 505 comprises a plurality of automated systems 510 to 530 coupled to ACD 125 and a human agent 535. In accordance with an embodiment of the present invention, automated systems 510 to 530 are identical. Although the figure illustrates five automated systems coupled to ACD 125, the number of automated systems coupled to ACD 125 can be varied and fall within the spirit and scope of the present invention.

When CTI server 120 receives incoming call 105 routed via network 110 and switch 115, it directs incoming call 105 to ACD 125. ACD 125 routes incoming call 105 to one of automated systems 510 to 530 depending upon the availability of the automated system. The automated system receives incoming call 105. In accordance with an embodiment of the present invention, the automated system includes an IVR that interacts with the caller. Each received call has an associated call health status. The automated system monitors the call health status and if the call health status is bad, the automated system transfers the call control to human agent 135.

In accordance with another embodiment of the present invention, the automated system comprises a machine interface via which human agent 135 interacts with the caller. Human agent 135 monitors the machine interface and identifies bad call health status of the monitored call. Human agent 135 intervenes to provide human support using the call history. In either embodiment, once human agent 135 rectifies the bad call health status by taking the required corrective actions, human agent 135 transfers the call control to the automated system. Further, the human agent converts the call heath status as healthy.

FIG. 6 is a block diagram of automated system 510 in accordance with an embodiment of the present invention. Automated system 510 comprises a call receiving module 605, a call navigating module 610, a call monitoring module 615 coupled to call navigating module 610 and a call control module 620 coupled to call monitoring module 615. Call receiving module 605 receives a plurality of calls from a plurality of callers which are directed by ACD 125. Call receiving module 605 comprises one of an IVR system and a machine interface to receive the call. The human agent receives the call through the machine interface. The machine interface includes a text-to-speech engine.

Call navigating module 610 comprises a call context gatherer unit 625. The navigation of calls includes navigating the interaction between the IVR and the caller and gathering the context of the call. Call context gatherer unit 625 captures all prompts (in text) and the corresponding Automatic Speech Recognition (ASR) transcribed text.

Call monitoring module 615 monitors the call health status of each call being navigated for the entire call duration by monitoring at least one call parameters. The call parameters comprise at least one of the call flow pattern, the events generated by the call-flow (for example, no-match event, help event, no-input event), the duration of the call, the caller's inputs, speech recognition scores on the caller's inputs, the prompts played back to the caller, a call priority status, the probability of a non-native caller accent, and a change in the caller's emotional state as perceived by the IVR. Each of the call parameters is assigned a threshold value prior to handling of the calls. The threshold value may either be a number or a context-dependent attribute. The call health status is determined based on whether the call parameters reside within the pre-assigned threshold values. If at least one of the call parameter crosses the pre-assigned threshold value, the call health status is referred to as one of bad call health. Call monitoring module 615 comprises a call log analyzer unit 630.

Call log analyzer unit 630 analyses call logs, ASR score, Action Classification Score (ACS), and number of events. The number of events includes help and no-match events. The speech recognition score, a quantitative score, is computed based upon the number of words correctly recognized in the callers' speech. The action classification score, a quantitative score, is computed based on the ability of the automated system to understand to the callers' query. A high ACS means that the automated system may handle the callers query while if the ACS is low, the call control is passed to the human agent. The no-match event is used by call log analyzer unit 630 to comprehend a caller's response. In an embodiment, a no-match event may be maintained using a counter and the counter may be configured to increment by one each time the automated system is unable to understand a caller's response. However, it will be apparent to a person skilled in the art that other logics used to maintain the no-match event fall within the spirit and scope of the present invention, for example voiceXML may be used to for creating voice user interfaces that use automatic speech recognition (ASR) and text-to-speech synthesis (TTS). Similarly, the help event may be determined using a counter. The counter maintains a track of the number of times a caller asks for the automated system's help. For example, each time a caller requests for help, the counter is incremented by one. Thus, the value of the counter may help in determining the caller's understanding and ease with automated system 510.

Call monitoring module 615 further detects a bad call health status of the call on the basis of one or more pre-assigned threshold values of one or more call parameters and passes the call control to a bad call health alert unit 635 of call control module 620. For example, a bad call health is detected if the ASR score is below 45, action classification score is below 50 and number of no-match event is greater than 2.

Call control module 620 further comprises a call control transfer unit 640 and a call context presentation unit 645. Bad call health alert unit 635 alerts the human agent upon detection of the bad call health status. In one embodiment of the present invention, bad call health alert unit 635 comprises a visual alert unit to provide visual cues to the human agent about the bad call health status. In another embodiment of the present invention, bad call health alert unit 635 comprises an audible alert unit to provide audio cues to the agent about the bad call health status. Call control transfer unit 640 transfers the call control to the human agent after alerting the human agent upon detection of the bad call health status. Call context presentation unit 645 displays the call context, gathered in call context gatherer unit 625, of the call with the bad call health status. The call context is displayed in a form comprehended by a human agent. The human agent rectifies the bad call health status by employing corrective actions.

It will be apparent to a person skilled in the art that various modules disclosed in conjunction with the disclosed embodiments of the present invention are logically unique entities. The functions performed by one or more of these modules may be merged in to a single program code for implementation on a network node. Further, one or more of these modules can be clubbed together to perform the desired functionality, for example, the call navigating module and the call monitoring module may be clubbed together. Various implementations imbibing the teachings of the present invention will be apparent to one skilled in the art. All these implementation are deemed to lie within the spirit and scope of the present invention.

FIG. 7 is a schematic view of a hybrid call handling system 700 provided by the present invention. Hybrid call handling system 700 comprises a plurality of calls originating from a plurality of callers 705[1−n], the plurality of callers coupled over a first network 710[1−n], one or more automated systems 510[1−n], a second network 715, and one or more human agent terminals 720[1−n] at their respective machine interfaces. The aforementioned plurality of calls is received by one or more automated systems 510[1−n] over first network 710[1−n]. The first network 710[1−n] and second network 715 may include a PSTN network, a cellular phone network, an IPLC network, a VoIP network, Internet, Intranet, a computer network, and combinations thereof. Automated systems 510[1−n] comprise one or more modules for receiving and navigating the plurality of calls from the plurality of callers, monitoring a call health status for each of the plurality of calls being navigated for the entire call duration, and controlling the call. Automated systems 510[1−n] of the present invention are coupled over second network 715 to human agent terminals 720[1−n] to rectify the bad call health status. In one embodiment of the present invention the human agent terminals 720[1−n] further comprises a text-to-speech engine for enabling a human agent to interact with callers 705[1−n].

The human agent to whom the call is transferred for rectification may be the same human agent who received the call initially. This human agent controls the flow of the call and guides the caller more actively based on the analysis of the call parameters. Alternatively, the call may be escalated for rectification to a different human agent. This human agent may have skill sets/training better suited to deal with calls with bad call health status. The two human agents may be co-located or may interact with each other through a network.

In another embodiment, the present invention provides a hybrid call handling system comprising a call receiving module, a call monitoring module coupled to the call receiving module to monitor a call health status, and a call control module coupled to the call monitoring module.

In yet another embodiment of the present invention, the present invention provides a hybrid call handling system comprising a plurality of calls originating from a plurality of callers, the plurality of callers coupled over a first network; one or more automated systems comprising one or more modules for at least one of (1) navigating a plurality of calls received from the plurality of callers (2) monitoring a call health status for each of the plurality of calls being navigated for an entire call duration (3) controlling the call, the one or more automated systems coupled over a second network to one or more human agent terminals comprising at least one of a call health alert unit and one or more human agents for rectification of bad call health.

An exemplary implementation of the present invention is described using FIGS. 8A-8F. When an incoming call is directed to an automated system, an IVR system in the automated system interacts with the caller. The IVR system, comprising a text to speech engine, welcomes the caller via a message IVR_R1 as illustrated in FIG. 8A. The caller hears the message IVR_R1 while the same message is recorded as a text message in the automated system. The caller's response is captured in message C_R1 in a text form. Once the caller responds to the message IVR_R1, the call parameters, for example, an ASR score, an ACS, a no-match event and a help event are computed.

FIG. 8B illustrates the IVR system response IVR_R2 to the callers message C_R1. The caller responds to IVR_R2 via a message C_R2. An ASR score, an ACS, a no-match event and a help event associated with the message C_R2 are computed. Since the aforesaid scores reside within the pre-assigned confidence values, the call control stays with the automated system.

FIG. 8C illustrates the IVR system response IVR_R3 to the callers message C_R2. The caller responds to IVR_R3 via a message C_R3. An ASR score, an ACS, a no-match event and a help event associated with the message C_R3 are computed. Since at least one of the aforesaid scores does not lie within the pre-assigned threshold value, the call health status is referred to as a bad call health status. The call control is then transferred to the human agent via an alert message “Agent Screen” as illustrated in FIG. 8D. The call history is provided to the human agent to enable the human agent to determine one or more possible causes of the bad call health status. The human agent responds to the caller's query via a message IVR_R4 that is converted to a speech message via the text to speech engine. The caller responds to the message IVR_R4 via a message C_R4. An ASR score, an Action Classifier Score, a no-match event and a help event associated with the message C_R4 are computed. Upon the human agent intervention, the aforesaid scores corresponding to the message C_R4 reside back within the pre-assigned threshold values as illustrated in FIG. 8E. The call control is transferred back to the automated system from the human agent. The call may then proceed as illustrated in FIG. 8F.

While typical embodiments have been set forth for the purpose of illustration, the foregoing description should not be deemed to be a limitation on the scope of the present invention. Accordingly, various modifications, adaptations and alternatives may occur to one skilled in the art without departing from the spirit and scope of the present invention.

What is claimed is:

1. A hybrid call handling method comprising:
navigating a plurality of received calls from a plurality of callers,
monitoring a call health status for each of the plurality of the calls being navigated for an entire call duration; and
notifying a bad call health status of the monitored call to a human agent for employing at least one rectification action.

2. The method of claim 1, wherein monitoring the call health status comprises monitoring one or more call parameters.

3. The method of claim 2, wherein the call parameters comprises at least one of a call flow, duration of the call, a caller's inputs, prompts played to the caller, a call priority status, probability of a non-native caller accent, the call history, and the stability of the caller's emotional state.

4. The method of claim 3, wherein the call history comprises a call log, a speech recognition score for each prompt, an action classification score for each prompt, and number of events for each prompt.

5. The method of claim 1, wherein notifying comprises transferring the call control of the monitored call to the human agent.

6. The method of claim 1, wherein notifying comprises intervention of the human agent for handling the monitored call.

7. The method of claim 1, wherein the call health status is determined on the basis of one or more pre-assigned threshold values to at least one of the call parameters.

8. The method of claim 1, further comprising alerting the human agent on detecting the bad call health status.

9. The method of claim 1, further comprising providing one or more call parameters to the human agent.

10. The method of claim 1, wherein the rectification action comprises:
analyzing the call parameters to determine at least one cause for the bad call health status; and
employing one or more corrective actions to rectify the bad call health status.

11. The method of claim 1, optionally comprising transferring call control from the human agent to the automated system upon rectification of the bad call health status.

12. A hybrid call handling system comprising at least one automated system and at least one human agent, the automated system comprising:
a call navigating module;
a call monitoring module coupled to the call navigating module to monitor a call health status; and
a call control module coupled to the call monitoring module.

13. The hybrid call handling system of claim 12, further comprising a call receiving module, wherein the call receiving module comprises at least one of an interactive voice response system and a machine interface.

14. The hybrid call handling system of claim 12, wherein the call navigating module comprises a call context gatherer unit.

15. The hybrid call handling system of claim 12, wherein the call monitoring module comprises a call log analyzer unit.

16. The hybrid call handling system of claim 12, wherein the call control module comprises a bad call health alert unit, a call control transfer unit, and a call context presentation unit.

17. The hybrid call handling system of claim 16, wherein the bad call health alert unit includes a visual alert unit, an audible alert unit, and a combination thereof.

18. A hybrid call handling system comprising:
a plurality of calls originating from a plurality of callers, the plurality of callers coupled over a first network;
one or more automated systems coupled to the first network, the automated system comprising one or more modules for at least one of:
navigating a plurality of received calls from a plurality of callers, monitoring a call health status for each of the plurality of the calls being navigated for an entire call duration; and
controlling the monitored call; and
one or more human agent terminals coupled to the automated system over a second network, the human agent terminal comprising at least one of:
a call health alert unit; and
one or more human agents for rectification of bad call health.

19. The system of claim 18, wherein the first and the second network include a PSTN network, a cellular phone network, an IPLC network, a VoIP network, Internet, Intranet, a computer network and a combination thereof.

20. The system of claim 18, wherein the human agent terminal further comprises a text-to-speech engine for enabling the human agent to interact with the caller.
